(19) United States
(12) Patent Application Publication
(10) Pub. No.: US 2024/0416155 A1
(43) Pub. Date: Dec. 19, 2024

(54) INFLATABLE FALL PROTECTION PAD FEATURING ROLLERS

(71) Applicant: The Boeing Company, Arlington, VA (US)

(72) Inventor: Tyler Ray Milliken, Charleston, SC (US)

(21) Appl. No.: 18/435,833

(22) Filed: Feb. 7, 2024

Related U.S. Application Data
(60) Provisional application No. 63/508,980, filed on Jun. 19, 2023.

(51) Int. Cl. A62B 1/22

(52) U.S. Cl. CPC A62B 1/22

(57) ABSTRACT

An inflatable fall protection pad comprises a deformable body defining an inflatable three-dimensional volume. The deformable body has a base wall, an upper wall, and sidewalls spanning the base wall and the upper wall. The inflatable fall protection pad further comprises a set of roller units mounted to the base wall along an exterior-facing surface of the base wall. The set of roller units is arranged in a multi-dimensional array. Tw or more roller units of the set are spaced apart from each other in a first dimension of the multi-dimensional array. Two or more roller units of the set are spaced apart from each other in a second dimension of the multi-dimensional array that is orthogonal to the first dimension.

### CROSS REFERENCE TO RELATED APPLICATIONS

This application claims priority to U.S. Patent Application Ser. No. 63/508,980, filed Jun. 19, 2023, the entirety of which is hereby incorporated herein by reference for all purposes.

### FIELD

The subject matter of the present disclosure relates generally to fall protection pads for restraining falls by persons or objects, and more particularly to a mobile inflatable fall protection pad that feature rollers to assist in moving the pad over a ground surface.

### BACKGROUND

Manufacturing and maintenance environments involve personnel working on structures that can be in a partially assembled or disassembled state. As an example, mobile structures such as aircraft frames or other large machinery as well as stationary structures such as buildings can involve personnel working at heights from which a fall could cause injury. When such structures are in a partially assembled or disassembled state, floors, walls, and railings may not be present, thereby providing locations where personnel could fall while performing manufacturing or maintenance tasks.

### SUMMARY

An inflatable fall protection pad comprises a deformable body defining an inflatable three-dimensional volume. The deformable body has a base wall, an upper wall, and sidewalls spanning the base wall and the upper wall. The inflatable fall protection pad further comprises a set of roller units mounted to the base wall along an exterior-facing surface of the base wall. The set of roller units is arranged in a multi-dimensional array. Two or more roller units of the set are spaced apart from each other in a first dimension of the multi-dimensional array. Two or more roller units of the set are spaced apart from each other in a second dimension of the multi-dimensional array that is orthogonal to the first dimension.

### BRIEF DESCRIPTION OF THE DRAWINGS

FIG. 1 schematically depicts an example inflatable fall protection pad in an inflated state.

FIG. 2 schematically depicts another view of the inflatable fall protection pad of FIG. 1 in the inflated state.

FIG. 3 depicts the inflatable fall protection pad of FIGS. 1 and 2 in the inflated state used within an example aircraft fuselage.

FIG. 4A schematically depicts example behavior of a portion of the inflatable fall protection pad of FIGS. 1 and 2 in the inflated state prior to a load being applied to an upper wall of the pad.

FIG. 4B schematically depicts example behavior of the portion of the inflatable fall protection pad of FIG. 4A in the inflated state responsive to application of a load to the upper wall of the pad.

FIGS. 5A, 5B, 5C, and 5D depict example roller units of the inflatable fall protection pad of FIGS. 1 and 2.

FIGS. 6A and 6B schematically depict an example roller unit showing example fastening techniques for mounting the roller unit to a base wall of the inflatable fall protection pad of FIGS. 1 and 2.

FIGS. 7A, 7B, and 7C schematically depict additional examples of a set of roller units mounted to the base wall of inflatable fall protection pads in accordance with the present disclosure.

FIGS. 8A, 8B, 8C, and 8D schematically depict an example of folding the inflatable fall protection pad of FIGS. 1 and 2 in a deflated state.

FIG. 9 is a flow diagram depicting an example method of using the inflatable fall protection pad of FIGS. 1 and 2.

### DETAILED DESCRIPTION

As described in further detail herein, an inflatable fall protection pad comprises a deformable body defining an inflatable three-dimensional volume. The deformable body has a base wall, an upper wall, and sidewalls spanning the base wall and the upper wall. The inflatable fall protection pad further comprises a set of roller units mounted to the base wall along an exterior-facing surface of the base wall. The set of roller units is arranged in a multi-dimensional array. Two or more roller units of the set are spaced apart from each other in a first dimension of the multi-dimensional array. Two or more roller units of the set are spaced apart from each other in a second dimension of the multi-dimensional array that is orthogonal to the first dimension.

The set of roller units of the inflatable fall protection pad enable the pad to be rolled over a ground surface. As an example, the pad can be of a mass, area, or volume that would otherwise be difficult for a person or group of people to move in the absence of the roller units due friction between the base wall and the ground surface.

As the set of roller units are spaced apart from each other over an area defined by the base wall, the deformable body of the pad, when deflated, can be folded for storage along one or more folding paths located between the roller units in both the first dimension and the second dimension. Additionally or alternatively, the deformable body of the pad can be rolled for storage.

Furthermore, a load applied to the upper wall, such as while arresting a fall, or otherwise supporting the weight of a person, can influence the mobility of the inflatable fall protection pad. As the set of roller units are spaced apart from each other over an area defined by the base wall, deformation of the base wall upon application of a load to the upper wall can cause the base wall to deform toward the ground surface. Such deformation can cause the base wall to initiate or increase contact with the ground surface. For example, one or more regions of the base wall located between the set of rollers can deform to contact the ground surface under a load applied to the upper wall, thereby increasing a lateral resistance to movement of the pad along the ground surface due to friction. Such deformation and increased contact between the base wall and the ground surface can provide a braking function having a braking force that is responsive to a load applied to the upper wall. The braking function can assist in stabilizing the pad. As the magnitude of the load increases, contact of the base wall with the ground surface can increase, thereby increasing the lateral resistance to movement of the pad along the ground surface.

In some examples, the set of roller units can be sized and arranged upon the base wall of the pad such that the base wall initiates contact with the ground surface responsive to a load being applied to the upper wall that attains or exceeds a predetermined magnitude. In this example, the base wall does not contact the ground surface when no load or a load that is less than the predetermined magnitude is applied to the upper wall of the pad. This approach can support mobility of the pad under conditions in which objects that do not attain or exceed the predetermined magnitude are supported by the upper wall of the pad. This approach also enables the braking function discussed above to be provided under select conditions in which a load applied to the upper wall attains or exceeds the predetermined magnitude.

As an example, the predetermined magnitude of the load can be selected to correspond to the static weight of a sample human adult applied to the upper wall. In this example or other examples, a conservative weight estimate of an adult can be used, such as 100 pounds or other suitable value, as an illustrative example. As another example, the predetermined magnitude can be selected to correspond to the dynamic force of a human adult falling from a given distance. As yet another example, the predetermined magnitude of the load can be selected to correspond to the static weight or dynamic force of a child.

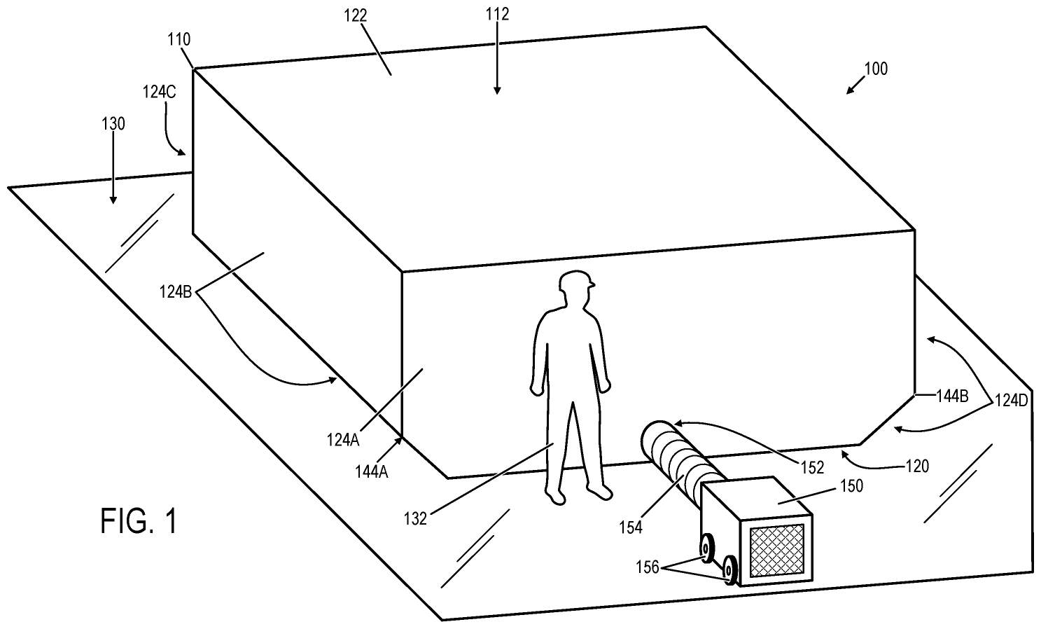

FIG. 1 schematically depicts an example inflatable fall protection pad 100 in an inflated state. Pad 100 includes a deformable body 110 defining an inflatable three-dimensional volume 112. Body 110 has a base wall 120, an upper wall 122, and sidewalls 124A, 124B, 124C, 124D spanning the base wall and the upper wall.

In at least some examples, body 110 can be formed from a flexible textile material or flexible continuous sheet material. Such materials can include a polymer such as nylon, vinyl, Polyvinyl chloride (PVC) and/or natural fiber, as examples. Textile materials can be treated with a polymer coating in at least some examples to reduce air permeability and/or provide water resistance.

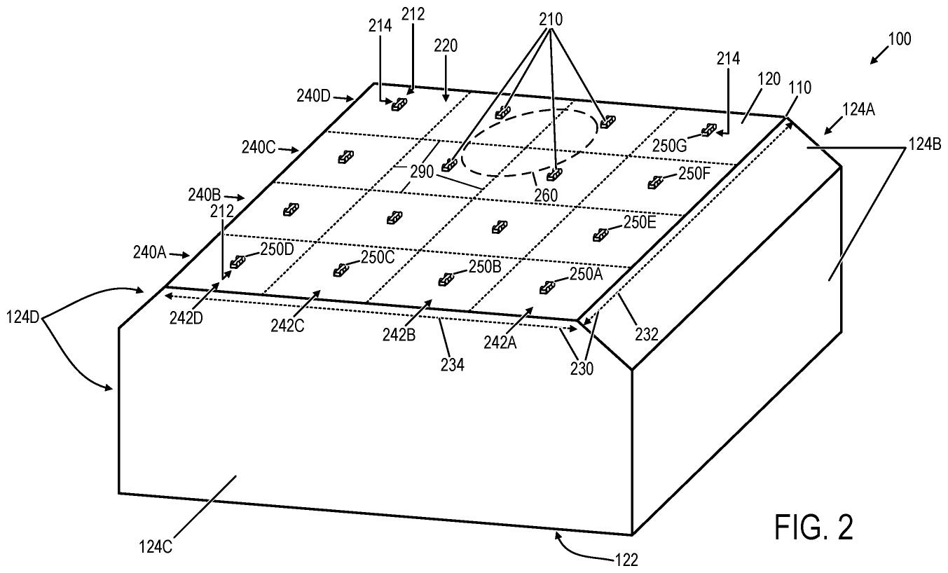

As described in further detail with reference to FIG. 2, pad 100 further comprises a set of roller units mounted to base wall 120. The set of roller units enable pad 100 to be rolled along a ground surface 130. In at least some examples, body 110 of pad 100 is of a size, weight, or volume that would otherwise be difficult for a person or group of people to move in the absence of the set of roller units due to friction between base wall 120 and ground surface 130. FIG. 1 schematically depicts a person 132 in relation to body 110 of pad 100 to provide an example scale of body 110. It will be understood that body 110 can be of other suitable size and/or shape.

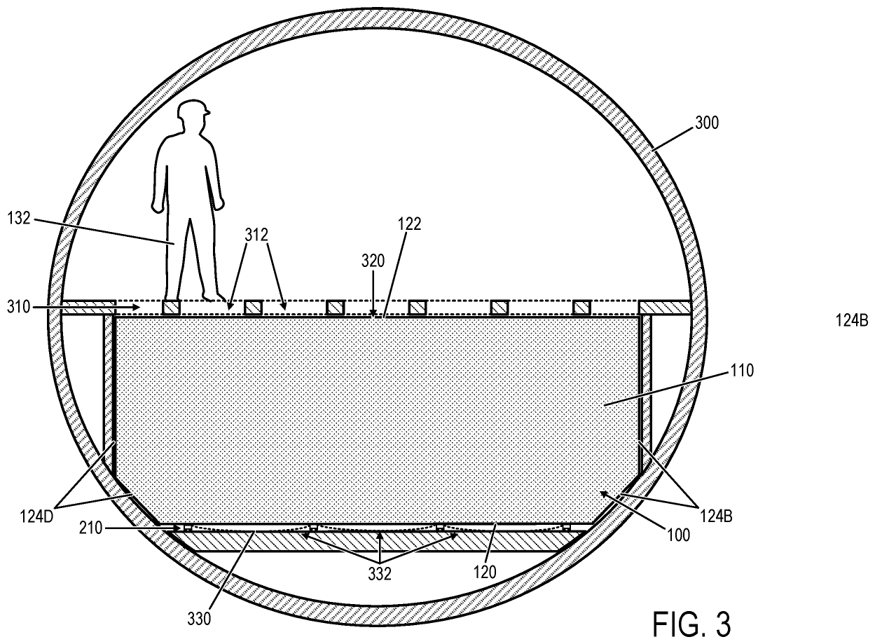

In at least some examples, upper wall 122 and base wall 120 have different areas, and sidewalls 124B and 124D taper between the base wall and the upper wall on opposite sides of body 110. In the example depicted in FIG. 1, upper wall 122 has a larger area than base wall 120, and sidewalls taper 124B and 124D taper inward from the upper wall to the base wall on opposite sides of body 110. Sidewalls 124B and 124D have respective profiles 144B and 144D that are shaped to accommodate a physical structure within or between which pad 100 can be used. As an example, the physical structure can include an interior of a fuselage of an aircraft, as described in further detail with reference to FIG. 3. It will be understood that body 110 can be of other suitable shape.

FIG. 1 schematically depicts an example fan assembly 150 that can be used to inflate body 110 and maintain body 110 in the inflated state. In this example, body 110 includes an opening 152 by which air is provided to inflate three-dimensional volume 112 defined by body 110. As an example, sidewall 124A defines opening 152. An outflow of fan assembly 150 can be fluidly coupled with opening 152 via a flexible or rigid conduit 154. In at least some examples, conduit 154 can form part of body 110. As another example, an outflow of fan assembly 150 can be mounted directly to opening 152. In at least some examples, fan assembly 150 can be mounted upon a set of rollers that enables the fan assembly to follow after pad 110 as the pad is moved between locations. In this example, conduit 154 also serves as a tether by which fan assembly 150 is mounted to body 110.

FIG. 2 schematically depicts another view of inflatable fall protection pad 100 of FIG. 1 in the inflated state in which base wall 120 is visible. In this example, base wall 120 has a rectangular shape. In other examples, base wall 120 can have a polygon shape of three, four, five or more sides. In other examples, base wall can have a circular shape, oval shape, or irregular shape.

Pad 100 includes a set of roller units 210 mounted to base wall 120 along an exterior-facing surface 220 of the base wall. The set of roller units 210 are arranged in a multi-dimensional array 230. Two or more roller units 212 of set 210 are spaced apart from each other in a first dimension 232 of multi-dimensional array 230, and two or more roller units 214 of the set 210 are spaced apart from each other in a second dimension 234 of multi-dimensional array 230 that is orthogonal to the first dimension.

As the set of roller units 210 are spaced apart from each other over an area defined by base wall 120, deformation of the base wall upon application of a load to upper wall 122 can initiate or increase contact of the base wall with the ground surface. For example, one or more regions of base wall 120 surrounding and located between the set of roller units 210, such as example region 260 can deform to contact or increase contact with the ground surface under a load applied to upper wall 122, thereby increasing a lateral resistance to movement of the pad along the ground surface due to friction. Such deformation and increased contact between base wall 120 and the ground surface can provide a braking function having a braking force that is responsive to a load applied to the upper wall.

In at least some examples, exterior-facing surface 220 of base wall 120 comprises a different material than an exterior-facing surface of upper wall 122 and/or sidewalls. As an example, exterior-facing surface 220 of base wall 120 can comprise a material having a higher coefficient of friction as compared to a material of exterior-facing surface of upper wall 122 and/or the sidewalls to facilitate the braking function described herein, for example due to the material's composition, texture, and so forth. In various and non-limiting examples of this, surface 220 can be made from such a material, or incorporate such a material, or be at least partially covered with such a material.

In at least some examples, the set of roller units 210 is arranged in two, three, four or more rows 240A, 240B, 240C, 240D, etc. of multi-dimensional array 230 in which each row includes two or more roller units. In the example depicted in FIG. 2, each row includes four roller units, such as roller units 250A, 250B, 250C, and 250D of row 240A. Each row of the set of roller units 210 can be spaced apart from each other at regular intervals (e.g., equal spacing), in an example. As another example, spacing between rows can vary across base wall 120 along first dimension 232. In still other examples, the set of roller units 210 is not arranged in rows.

In at least some examples, the set of roller units 210 is arranged in two, three, four or more columns 242A, 242B, 242C, 242D, etc. of multi-dimensional array 230 in which each column includes a roller unit of each row. In the example depicted in FIG. 2, each column includes four roller units, such as roller units 250A, 250E, 250F, and 250G of column 242A. Each column of the set of roller units 210 can be spaced apart from each other at regular intervals (e.g., equal spacing), as an example. As another example, spacing between columns can vary across base wall 120 along second dimension 234. In still other examples, the set of roller units 210 is not arranged in columns.

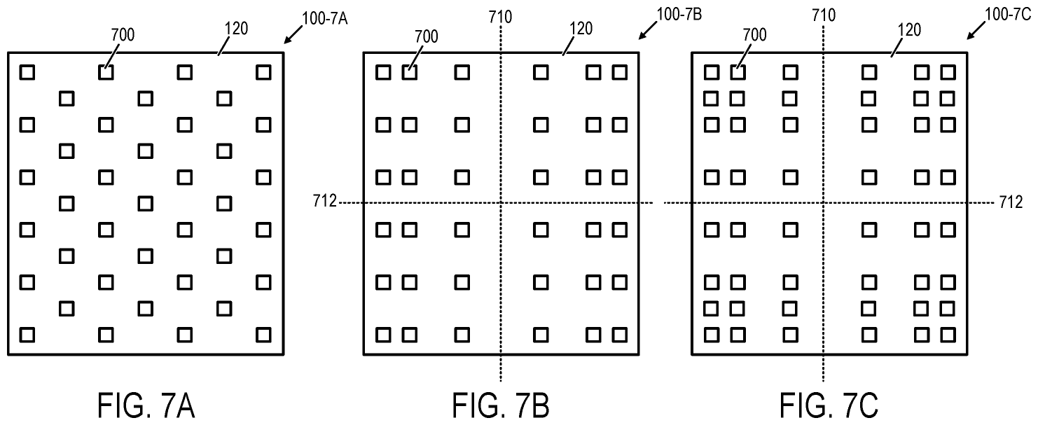

Furthermore, as described in further detail with reference to FIGS. 7A, 7B, and 7C, in at least some examples, the set of roller units 210 can be arranged symmetrically about a midplane of deformable body 110 that bisects base wall 120 along an axis that is parallel to first dimension 232. Additionally or alternatively, the set of roller units 210 can be arranged symmetrically about a midplane of deformable body 110 that bisects base wall 120 along an axis that is parallel to second dimension 234. Symmetry of roller unit arrangement about one or both midplanes of deformable body 110 can provide consistent performance and/or responsiveness of pad 100 in terms of mobility and braking function.

In the example of FIG. 2, the set of roller units 210 includes sixteen roller units distributed over base wall 120 that are arranged in a four by four array. It will be understood that other suitable quantities and/or arrangements of roller units can be distributed across base wall 120 to enable pad 100 to be rolled across a ground surface with a given lateral force applied to the pad. For a given application, the quantity and arrangement of roller units mounted to base wall 100 can be selected to provide a suitable level of mobility when upper wall 122 is unloaded as well as a suitable level of braking force when a load is applied to upper wall 122.

As an example, to support mobility of pad 100, a quantity of roller units per unit area of base wall 120 can be selected to provide a desired level of lateral resistance to movement of pad 100 along a ground surface when a load is not being applied to upper wall 122. For example, lateral resistance to movement pad 100 along a ground surface when upper wall 122 is unloaded can be reduced by increasing a quantity of roller units per unit area of base wall 120.

To support a braking function, the quantity of roller units per unit area of base wall 120 can be selected to provide a desired level of lateral resistance to movement of pad 100 along a ground surface when a load is applied to upper wall 122. For example, a braking force provided in response to application of a load to upper wall 122 can be increased by reducing a quantity of roller units per unit area of base wall 120.

In at least some examples, deformable body 110 includes a plurality of internal baffle walls within the inflatable three-dimensional volume that interface with an interior-facing surface of base wall 120. In such examples, each roller unit of the set of roller units 210 can be mounted to base wall 120 at a respective location within a region bounded on at least two opposing sides by baffle walls of the plurality of internal baffle walls that interface with the interior-facing surface of the base wall. As an example, reference numeral 290 in FIG. 2 depicts an example region bounded on opposing sides by baffle walls within which a roller unit of the set of roller units 210 is mounted. This mounting approach can facilitate the braking function by locating the roller units within regions of base wall 120 that exhibit greater deformation than regions secured to baffle walls.

FIG. 3 depicts inflatable fall protection pad 100 of FIGS. 1 and 2 in the inflated state as may be used within an aircraft fuselage 300. In this example, lower deck 330 of fuselage 300 refers to an example ground surface upon which the set of rollers 210 at least partially support pad 100. Furthermore, in this example, sidewalls 124C and 124D of pad 100 conform generally to structural features of fuselage 300, enabling pad 100 to be moved along lower deck 330 (e.g., along an axis orientated into and out of the page) via the set of rollers 210.

Within FIG. 3, person 132 is located within fuselage 300 above pad 100. During manufacturing or maintenance of fuselage 300, for example, portions of upper deck 310 identified schematically at 312 may be not present, representing gaps through which person 132 could fall. As an example, temporary floor panels installed to facilitate assembly of a portion of the fuselage may then be required to be removed in order to install permanent floor panels. After removal of the temporary floor panels and prior to installation of permanent floor panels, open gaps between beams and other support structure may present a fall hazard for personnel working in the area. As pad 100 occupies a volume of space beneath upper deck 310, the pad can arrest a fall of person 132 or otherwise support the weight of the person. An example load 320 applied to upper surface 122 is depicted schematically in FIG. 3, which can represent the static weight or dynamic force of person 132 upon pad 100. As depicted schematically at 332, regions of base wall 120 surrounding roller units 210 deforms to initiate or increase contact with ground surface 330. As previously described, deformation of base wall 120 responsive to a load applied to upper surface 122 that initiates or increases contact with the ground surface can provide a braking function that increases lateral resistance to movement of the pad relative to the ground surface. For example, in some embodiments, contact of the ground surface under such a load may effectively prevent any lateral movement of the pad, stabilizing the pad in position until the load is removed.

In some embodiments, the pad may be configured to deform responsive to a load in locations other than of the base wall 120. For example, referring to the pad 100 of FIG. 3, one or more portions of side walls 124B, 124D may be configured to deform outward responsive to a load 320 on the upper surface 122, such as due to the arrangement of internal baffle walls or other interior structure. Such outward deformation of the side walls may be in addition to the deformation of the base wall 120. In an embodiment such as shown in FIG. 3, in which the pad is of a shape and size to occupy an internal volume of a fuselage 300 that is bounded by a ground surface and other structural features such as vertical walls or beams, and depending on the amount of clearance between the exterior surfaces of the pad and these structural features, the pad may be configured so that such deformation may be of an extent to urge at least a portion of the exterior surface of the side walls against these structural features, such as to enhance lateral resistance to movement of the pad when it is under load. In such embodiments, the exterior surface(s) of the side walls may incorporate a material having a desired coefficient of friction, for example to facilitate a braking function.

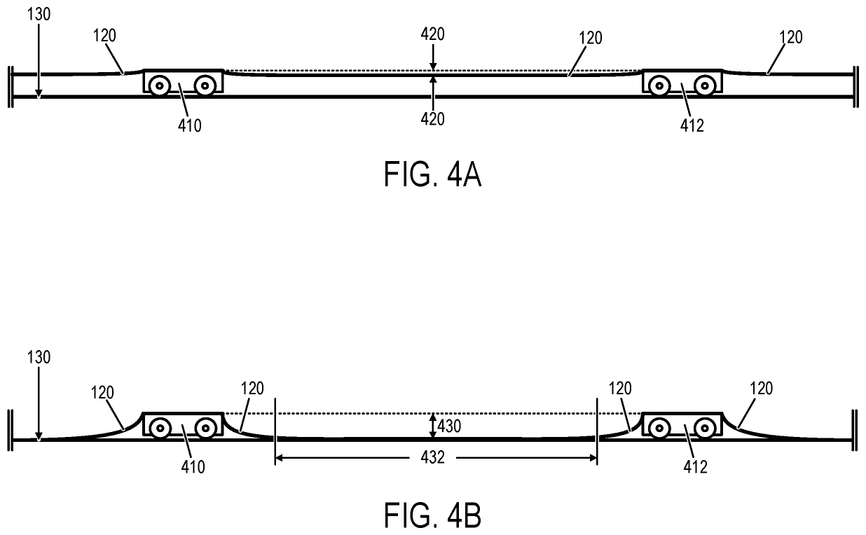

FIG. 4A schematically depicts example behavior of a portion of inflatable fall protection pad 100 in the inflated state prior to a load being applied to upper wall 122. Within FIG. 4A, example roller units 410 and 412 of the set of roller units 210 are schematically depicted in contact with ground surface 130. Also within FIG. 4A, roller units 410 and 412 at least partially support base wall 120 above ground surface 130. Roller units 410 and 412 can refer to any two neighboring roller units of set 210. Deformation of base wall 120 between roller units 410 and 412 due to the weight of pad 100 is depicted schematically at 420 in FIG. 4A. It will be understood that deformation of base wall 120 depicted schematically at 420 may contact ground surface 130 under the weight of pad 100, in some examples.

FIG. 4B schematically depicts example behavior of the portion of inflatable fall protection pad 100 in the inflated state shown in FIG. 4A responsive to application of load being applied to upper wall 122. Within FIG. 4B, deformation of base wall 120 between roller units 410 and 412 depicted schematically at 430 due to application of the load to upper wall 122 has increased such that the base wall contacts ground surface 130. Responsive to application of the load to upper wall 122, a surface area of base wall 120 that contacts ground surface 130 has increased relative to FIG. 4A, as depicted schematically at 432. The surface area of base wall 120 that contacts ground surface 130 may be located within region 260 of FIG. 2, as an example.

In this example, deformation of base wall 120 upon application of the load to upper wall 122 initiates and increases contact of the base wall with the ground surface. Additionally, a contact force between base wall 120 and ground surface 130 increases as a result of the load being applied to upper wall 122, thereby increasing a lateral resistance to movement of the pad along the ground surface due to friction. Such deformation and increased contact between base wall 120 and ground surface 130 provides a braking function that is responsive to the load applied to upper wall 122.

In at least some examples, base wall 120 does not contact the ground surface until a load applied to upper wall 122 attains or exceeds a predetermined magnitude. For example, FIG. 4A can depict an example in which no load or a load applied to upper wall 122 is less than the predetermined magnitude, and FIG. 4B can depict an example in which the load applied to the upper wall attains or exceeds the predetermined magnitude. This approach can be used to initiate the braking function responsive to the load being applied to the upper wall attaining or exceeding the predetermined magnitude. This approach also supports mobility of the pad by the base wall not resisting movement of the pad over the ground surface when the load does not attain or exceed the predetermined magnitude. In some examples, a “load of a predetermined magnitude” can describe a load that is localized to a given area of the upper wall. In other words, in some embodiments, the pad may be configured (e.g., by means of a configuration of internal baffle walls or other interior structure) so that a portion of the bottom surface deforms sufficiently to contact the ground surface only when a load of a predetermined magnitude is applied within a given (e.g. localized) area of the top surface. Such embodiments may be useful in a context in which, for example, it may not be desirable for the bottom surface of the pad to “bottom out” against a ground surface due to the presence of tools or other objects on different areas of the top surface of the pad, even though the combined weight of such items may meet or exceed the predetermined magnitude, while still having the desired effect of the presence of such a load within a given area of the top surface, such as the weight of a person on the top surface, causing enough of the bottom surface of the pad to contact the ground surface that the pad is restricted from lateral movement until the load is removed. In other embodiments, the pad may be configured so that the bottom surface will “bottom out” against a ground surface regardless of the position (or positions) of the predetermined load on the top surface.

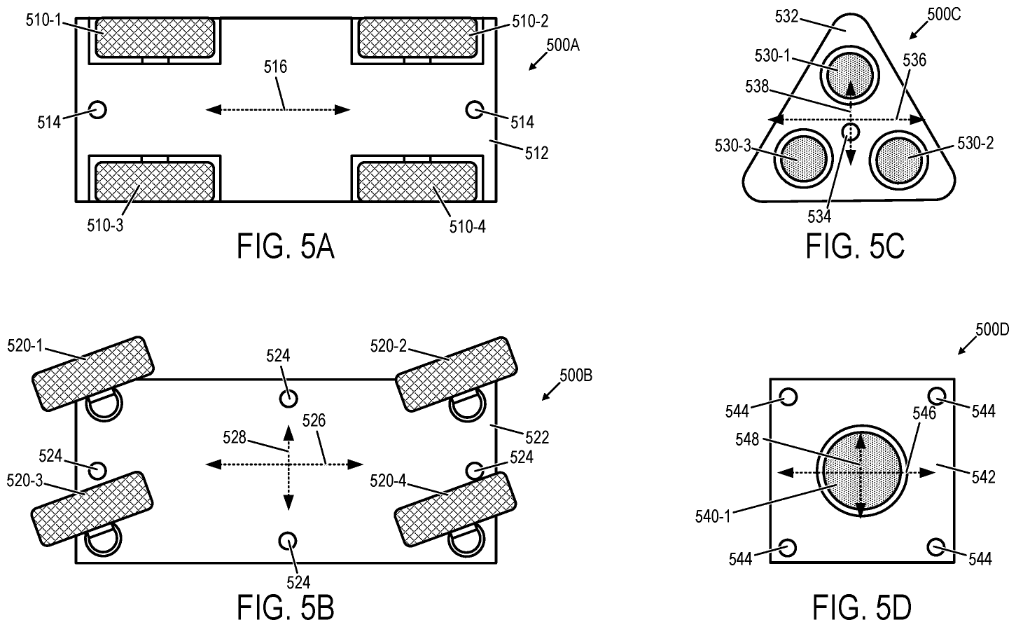

As previously described with reference to FIG. 2, the set of roller units 210 include multiple roller units distributed over exterior-facing surface 220 of base wall 120. FIGS. 5A-5D schematically depict examples of roller units 500A, 500B, 500C, and 500D that can be mounted to base wall 120 of inflatable fall protection pad 100. The example roller units of FIGS. 5A-5D are schematically depicted from a bottom view facing upward from the ground surface.

Each roller unit of the set of roller units 210 includes one or more rollers. Examples of rollers include wheels, wheeled casters, and ball casters. The one or more rollers of each roller unit of the set of roller units 210 can have a fixed rolling orientation along a single axis, such as a fixed axle wheel, or an omnidirectional rolling orientation within a plane, such as a wheeled caster or ball caster.

As previously described with reference to FIGS. 1 and 2, sidewalls 124B and 124D of pad 100 taper between base wall 120 and upper wall 122 on opposite sides of deformable body 110. The opposite sides of the deformable body in this example can be parallel to the fixed rolling orientation of the set of rollers. Thus, in this example, the profile of sidewalls 124B and 124D configured to be accommodated by a particular structure can be oriented parallel to the fixed rolling orientation to enable pad 100 to be moved within or between features of the structure.

Each roller unit can include one, two, three, or more wheels, wheeled casters, or ball rollers. Two or more fixed axle wheels of each roller unit having fixed rolling orientations can be aligned with each other along a common axis. In some examples, three, four, or more rollers of each roller unit can be arranged to form a polygon shape for localized stability of base wall 120, such as a three-sided triangular configuration, four-sided rectangular configuration, etc. In other examples, two or more rollers of each roller unit can be arranged along an axis in a linear configuration.

Each roller unit includes a rigid body that interfaces with exterior-facing surface 220 of base wall 120 upon which the one or more rollers of the roller unit are rotatably mounted. The rigid body of each roller unit can provide a region of base wall 120 to which the rigid body is mounted that does not deform. The rigid body of each roller unit can be mounted to base wall 120 via one or more mechanical fasteners (e.g., bolts, rivets, screws, clips, etc.), hook and loop fasteners, adhesives, and/or stitching.

Roller unit 500A of FIG. 5A includes four fixed axle wheels 510-1, 510-

2, 510-3, and 510-4 rotatably mounted to a rigid body 512 in a rectangular configuration. Example mechanical fasteners 514 by which rigid body 512 can be mounted to base wall 120 are schematically depicted in FIG. 5A. Roller unit 500A has a fixed rolling orientation along axis 516 in this example.

Roller unit 500B of FIG. 5B includes four wheeled casters 520-1, 520-2, 520-3, 520-4 rotatably mounted to a rigid body 522 in a rectangular configuration. Example mechanical fasteners 524 by which rigid body 522 can be mounted to base wall 120 are schematically depicted in FIG. 5B. Roller unit 500B has an omnidirectional rolling orientation within a plane as indicated by orthogonal axes 526 and 528. Roller unit 500B can alternatively include four ball casters.

Roller unit 500C of FIG. 5C includes three ball casters 530-1, 530-2, and 530-3 rotatably mounted to a rigid body 532 in a triangular configuration. An example mechanical fastener 534 by which rigid body 532 can be mounted to base wall 120 is schematically depicted in FIG. 5C. Roller unit 500C has an omnidirectional rolling orientation within a plane as indicated by orthogonal axes 536 and 538. Roller unit 500C can alternatively include three wheeled casters or three fixed axle wheels.

Roller unit 500D of FIG. 5D includes a single ball caster 540-1 rotatably mounted to a rigid body 542. Example mechanical fasteners 544-1, 544-2, 544-3, and 544-4 by which rigid body 542 can be mounted to base wall 120 are schematically depicted in FIG. 5D. Roller unit 500D has an omnidirectional rolling orientation within a plane as indicated by orthogonal axes 546 and 548. Roller unit 500D can alternatively include one wheeled caster or one fixed axle wheel.

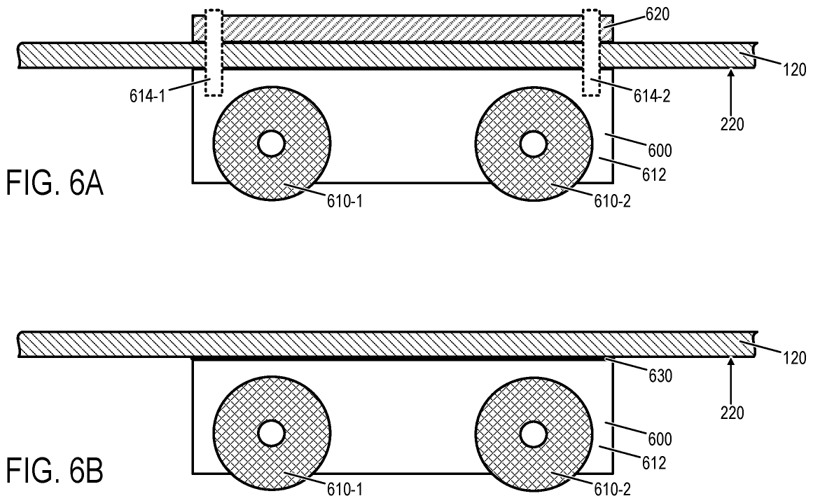

FIGS. 6A and 6B schematically depict an example roller unit 600 from a side view showing example fastening techniques for mounting the roller unit to base wall 120 of pad 100 along exterior-facing surface 220. In this example, roller unit 600 includes example rollers 610-1 and 610-2 rotatably mounted to a rigid body 612.

Within FIG. 6A, rigid body 612 is mounted to base wall 120 along exterior-facing surface 220 via mechanical fasteners 614-1 and 614-2. Furthermore, in this example, a backing plate 620 is positioned on an opposite side of base wall 120 from roller unit 600. Mechanical fasteners 614-1 and 614-2, in this example, pass through base wall 120 and engage with backing plate 620.

Within FIG. 6B, rigid body 612 is mounted to base wall 120 along exterior-facing surface 220 via hook and loop fasteners or an adhesive, represented schematically by reference numeral 630.

Hook and loop fasteners can provide the advantage of enabling roller unit 600 to be removed from base wall 120 and/or repositioned at a different location or orientation relative to the base wall. As an example, base wall 120 can include a hook side or a loop side of hook and loop fasteners along some or all of exterior-facing surface 220 to enable the quantity, orientation, arrangement, and type of roller units of the set of roller units mounted to the base wall to be reconfigured for different applications.

In the examples depicted in FIGS. 5A-5D and 6A-6B, each roller unit includes a rigid body upon which one or more rollers are rotatably mounted. In another example, multiple roller units that form a row (e.g., 240A-240D of FIG. 2) or a column (e.g., 242A-242D of FIG. 2) can share a rigid body that spans the multiple roller units. This configuration would not permit folding or rolling of deformable body 110 about a dimension that is orthogonal to the rows or columns that feature the shared rigid body that spans multiple roller units, but would permit folding or rolling of the deformable body about a dimension that is parallel to such rows or columns. Referring to FIG. 2, for example, rows 240A-240D can each feature multiple roller units that share a rigid body that spans the multiple roller units of that row. In this example, deformable body 110 can be folded and/or rolled about a dimension that is parallel to rows 240A-240D. Furthermore, in this example, deformation of base wall 120 can occur at one or more regions located between rows 240A-240D responsive to application of a load to upper wall 122. As another example, columns 242A-242D can each feature multiple roller units that share a rigid body that spans the multiple roller units of that column. In this example, deformable body 110 can be folded and/or rolled about a dimension that is parallel to columns 242A-242D. Furthermore, in this example, deformation of base wall 120 can occur at one or more regions located between columns 242A-242D responsive to application of a load to upper wall 122.

FIGS. 7A, 7B, and 7C schematically depict additional examples of a set of roller units mounted to base wall 120 of inflatable fall protection pads.

In FIG. 7A, inflatable fall protection pad 100-7A includes multiple roller units 700 distributed over base wall 120 in rows and columns having a staggered configuration.

In FIG. 7B, inflatable fall protection pad 100-7B includes multiple roller units 700 distributed over base wall 120 in rows and columns in which a spacing between columns orientated parallel to a first midplane 710 decreases in each direction moving outward from the first midplane. Alternatively, the spacing between columns can increase or otherwise vary in each direction moving outward from first midplane 710. The arrangement of roller units 700 in FIG. 7B is symmetric about first midplane 710, in this example. A spacing between rows orientated parallel to a second midplane 712 that is orthogonal to the first midplane 710 is regular or consistent among rows, in this example. The arrangement of roller units 700 in FIG. 7B is symmetric about second midplane 712, in this example.

In FIG. 7C, inflatable fall protection pad 100-7C includes multiple roller units 700 distributed over base wall 120 in rows and columns in which a spacing between columns orientated parallel to first midplane 710 decreases in each direction moving outward from the first midplane. Alternatively, the spacing between columns can increase or otherwise vary in each direction moving outward from first midplane 710. The arrangement of roller units 700 in FIG. 7C is symmetric about midplane 710 in this example. Additionally, a spacing between rows orientated parallel to second midplane 712 decreases in each direction moving outward from the second midplane. Alternatively, the spacing between rows can increase or otherwise vary in each direction moving outward from second midplane 712. The arrangement of roller units 700 in FIG. 7C is symmetric about second midplane 712, in this example.

Although not shown in the drawings, the roller units in some embodiments may be configured to provide a self-braking feature, such as a braking feature that may be independent of the self-braking feature provided by the deformation of the bottom wall of the pad under load as discussed above. Further, such a braking feature may be “self-braking” in that it is responsive to a load being applied to the pad. For example, the rollers 610 of the example roller units 600 depicted in FIGS. 6A and 6B may be rotatably mounted to rigid body 612 by means of one or more axles that are spring-biased relative to rigid body 612, such that each of such axles is biased to provide a sufficient amount of vertical clearance between the top of the roller 610 and the exterior-facing surface 220 of base wall 120 so that the roller may roll when the pad is not bearing a load, such as a load of predetermined magnitude. However, the biasing of such axles may be calibrated (for example, by means of the configuration of the springs, the weight of the pad, the number of rollers, and so forth) so that this vertical clearance is reduced upon a load being applied to the pad, for example such that the rollers are urged into contact with the base wall 120 responsive to a load, for example a load of a predetermined magnitude applied to the top surface of the pad, in a manner that may effectively prevent the rollers from rolling due to friction and thereby arresting lateral movement of the pad. Other roller unit configurations may provide a similar self-braking feature. In some embodiments, one or more of the roller units may provide such a self-braking feature in addition to, or as an alternative to, the braking feature provided by the deformation of the side and/or bottom wall(s) of the pad as discussed herein.

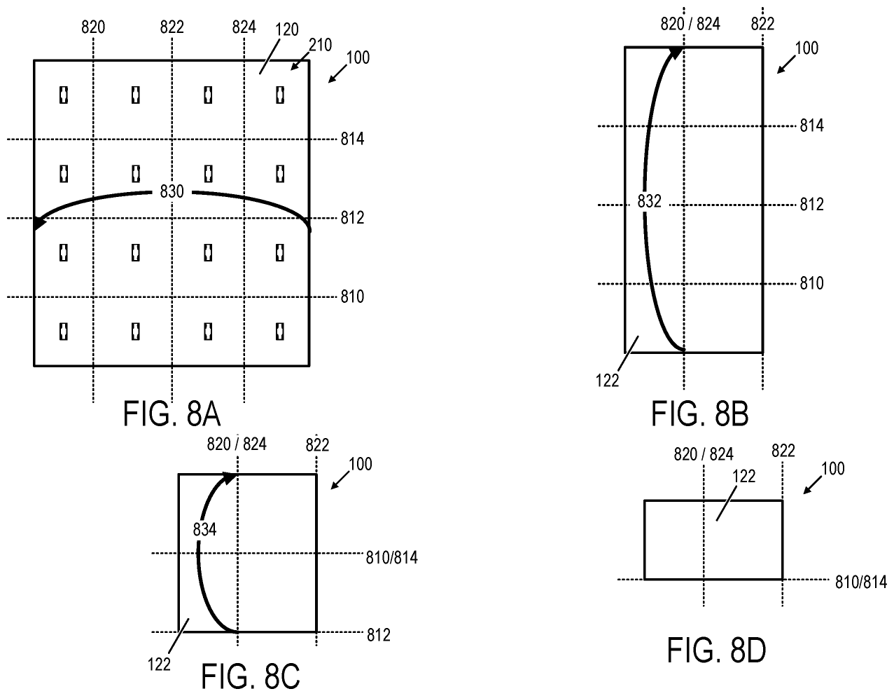

FIGS. 8A, 8B, 8C, and 8D schematically depict an example of inflatable fall protection pad 100 in a deflated state being folded from an unfolded state to a folded state for storage. Additionally or alternatively, pad 100 can be rolled from an unrolled state to a rolled state for storage.

In FIG. 8A, base wall 120 and the set of roller units 210 are visible. A plurality of available folding paths spanning pad 100 are depicted schematically in FIG. 8A at 810, 812, and 814 along first dimension 232, and at 820, 822, and 824 along second dimension 234 that is orthogonal to the first dimension. As an example, pad 100 can be folded as indicated by reference numeral 830 along folding path 822 to obtain the folded configuration of FIG. 8B in which the upper wall 122 is now visible. As another example shown in FIG. 8B, pad 100 can be folded again along folding path 812 as indicated by reference numeral 832 to obtain the folded configuration of FIG. 8C. As another example shown in FIG. 8C, pad 100 can be folded again along folding paths 810/814 as indicated by reference numeral 834 to obtain the folded configuration of FIG. 8D. It will be understood that pad 100 can be folded in various ways along one or more folding paths that are located along one or more regions of deformable body 110 that do not have one or more roller units mounted to the base wall 120.

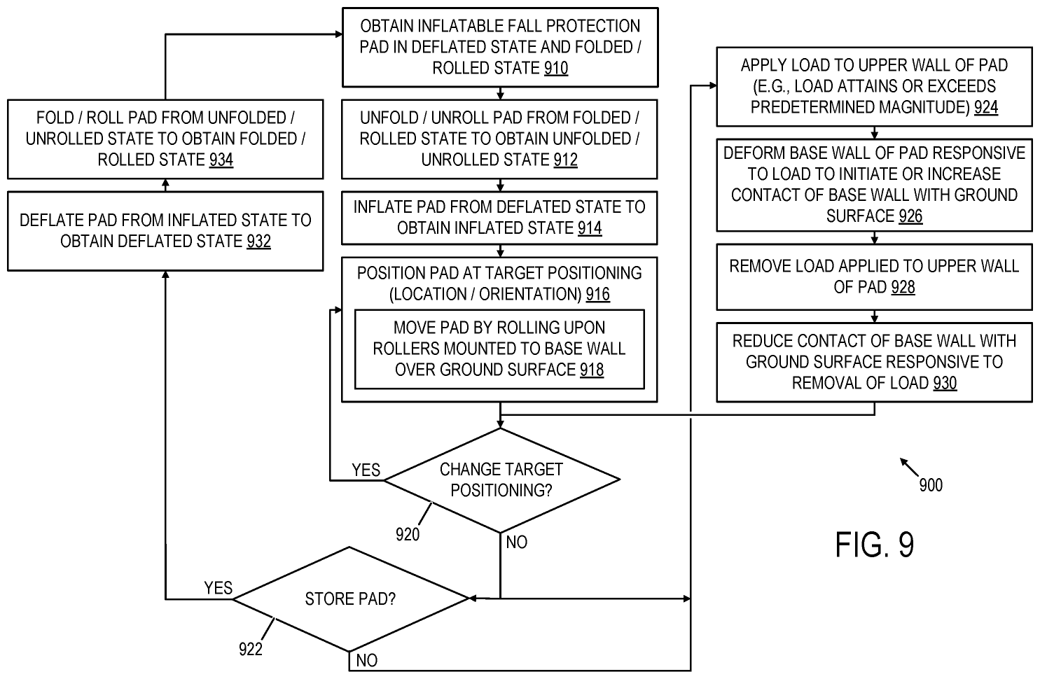

FIG. 9 is a flow diagram depicting illustrative, non-exclusive examples of method 900 of using an inflatable fall protection pad that includes a plurality of rollers. As is evident from the following description, some steps may be optional or may correspond to an optional version of a method according to the present disclosure. That said, not all methods according to the present disclosure are required to include the steps illustrated. The methods and steps illustrated in FIG. 9 are not limiting and other methods and steps are within the scope of the present disclosure, including methods having greater than or fewer than the number of steps illustrated, and/or may include steps in a different order, as understood from the discussions herein. As an example, method 900 can be performed using inflatable fall protection pad 100 having a plurality of roller units 210 mounted to base wall 120, as described herein.

At 910, the method includes obtaining an inflatable fall protection pad (e.g., 100) that includes a plurality of rollers.

At 912, the method includes unfolding and/or unrolling the pad from a folded and/or rolled state to obtain an unfolded and unrolled state of the pad.

At 914, the method includes inflating the pad from the deflated state to obtain the inflated state of the pad. As an example, fan assembly 150 of FIG. 1 can be operated to supply air to pad 100 via conduit 154 and opening 152.

At 916, the method includes positioning the pad at a target positioning, which can include a target location and/or orientation. As an example, the pad can be moved at 918 by rolling the pad over a ground surface upon the rollers of the plurality of roller units mounted to the base wall.

At 920, if the target positioning (e.g., location and/or orientation) of the pad is to be changed, the method can return to 916 wherein the pad can be repositioned at the target positioning.

At 922, if the pad is to be stored, the method can proceed to 932. At 932, the method includes deflating the pad from the inflated state to obtain the deflated state of the pad. As an example, fan assembly 150 of FIG. 1 can be turned off and/or disconnected from opening 152 and/or conduit 154 of pad 100. At 934, the method includes folding and/or rolling the pad from the unfolded and unrolled state to obtain the folded and/or rolled state of the pad suitable for storage.

At 924, the method includes applying a load to an upper wall of the pad. As an example, the load applied to the upper wall of the pad can attain or exceed a predetermined magnitude at which the braking function is initiated due, at least in part, to deformation of the base wall of the pad to initiate contact with the ground surface. Additionally or alternatively, the braking function can be initiated due to deformation of sidewalls of the pad to initiate contact with surrounding structures.

At 926, the method includes deforming the base wall of the pad responsive to the load being applied to the upper wall to initiate or increase contact of the base wall with the ground surface. Additionally, the sidewalls of the pad may be deformed at 926 responsive to the load applied at 924 to initiate or increase contact of the sidewalls with surrounding structures. Increased contact of the base wall with the ground surface can provide a braking function, as previously described. Additionally or alternatively, deformation of the sidewalls can initiate and/or increase contact between the side walls and surrounding structures, thereby providing the braking function. Referring again to FIG. 3, for example, sidewalls 124B and 124D can deform under the applied load to initiated contact or increase contact with surrounding structures of aircraft fuselage 300.

At 928, the method includes removing the load applied to the upper wall of the pad. At 930, contact of the base wall with the ground surface is reduced or discontinued responsive to removal of the load. Additionally or alternatively, contact of the sidewalls with surrounding structures is reduced or discontinued responsive to removal of the load.

As noted above, methods in accordance with the present disclosure are not required to include all of the steps described or shown in FIG. 9, or in the illustrated order, and/or may include multiple iterations of certain steps. As one example, a method may include positioning the pad at a target positioning location (at 916 and/or 918) prior to inflating it (at 914), and so forth. In a related example, a method may include positioning the pad (at 916 and/or 918), inflating the pad (at 914), and then orienting the pad (at 916).

Further, the disclosure comprises configurations according to the following clauses.

Clause 1. An inflatable fall protection pad, comprising: a deformable body defining an inflatable three-dimensional volume, the deformable body having a base wall, an upper wall, and sidewalls spanning the base wall and the upper wall; and a set of roller units mounted to the base wall along an exterior-facing surface of the base wall, the set of roller units arranged in a multi-dimensional array, wherein two or more roller units of the set are spaced apart from each other in a first dimension of the multi-dimensional array, and wherein two or more roller units of the set are spaced apart from each other in a second dimension of the multi-dimensional array that is orthogonal to the first dimension.

Clause 2. The inflatable fall protection pad of clause 1, wherein the set of roller units is arranged in three or more rows of the multi-dimensional array in which each row of the three or more rows includes two or more roller units.

Clause 3. The inflatable fall protection pad of clause 2, wherein each row of the three or more rows are spaced apart from each other at regular intervals.

Clause 4. The inflatable fall protection pad of clause 2, wherein each row of the three or more rows are spaced apart from each other at varying intervals.

Clause 5. The inflatable fall protection pad of clause 2, wherein the set of roller units is arranged in three or more columns of the multi-dimensional array in which each column of the three or more columns includes a roller unit of each row of the three or more rows.

Clause 6. The inflatable fall protection pad of any of clauses 1-5, wherein one or more regions of the base wall surrounding each roller unit of the set of roller units is deformable; and wherein application of a load to the upper wall of the deformable body deforms one or more of said regions of the base wall toward a ground surface upon which the set of roller units support the deformable body.

Clause 7. The inflatable fall protection pad of clause 6, wherein one or more of said regions of the base wall is configured to deform toward the ground surface to the extent that at least a portion of the base wall contacts the ground surface when the load is of a predetermined magnitude.

Clause 8. The inflatable fall protection pad of clause 7, wherein contact of the ground surface by a portion of the base wall increases a lateral resistance to movement of the inflatable fall protection pad along the ground surface.

Clause 9. The inflatable fall protection pad of any of clauses 1-8, wherein at least a portion of the base wall is configured to contact a ground surface upon which the set of roller units support the deformable body upon application of a load of a predetermined magnitude to the upper wall of the deformable body.

Clause 10. The inflatable fall protection pad of clause 9, wherein the surface area of the base wall that contacts the ground surface increases when the magnitude of the load increases.

Clause 11. The inflatable fall protection pad of clause 10, wherein contact of the ground surface by a portion of the base wall increases a lateral resistance to movement of the inflatable fall protection pad along the ground surface, and wherein the lateral resistance increases as the surface area of the base wall in contact with the ground surface increases.

Clause 12. The inflatable fall protection pad of any of clauses 1-11, wherein each roller unit of the set of roller units includes: a rigid body that interfaces with the exterior-facing surface of the base wall, and one or more rollers rotatably mounted to the rigid body.

Clause 13. The inflatable fall protection pad of clause 12, wherein the one or more rollers of each roller unit of the set of roller units include one or more wheels having a fixed rolling orientation.

Clause 14. The inflatable fall protection pad of clause 13, wherein the one or more rollers of each roller unit of the set of roller units includes four wheels arranged in a rectangular configuration.

Clause 15. The inflatable fall protection pad of clause 13, wherein the sidewalls taper between the base wall and the upper wall on opposite sides of the deformable body; and wherein the opposite sides of the deformable body are parallel to the fixed rolling orientation.

Clause 16. The inflatable fall protection pad of clause 12, wherein the one or more rollers of each roller unit of the set of roller units include one or more casters having an omnidirectional rolling orientation.

Clause 17. The inflatable fall protection pad of any of clauses 1-16, wherein the upper wall and the base wall have different areas.

Clause 18. The inflatable fall protection pad of clause 17, wherein the upper wall has a larger area than the base wall; and wherein the sidewalls taper inward from the upper wall to the base wall on opposite sides of the deformable body.

Clause 19. The inflatable fall protection pad of any of clauses 1-18, wherein the deformable body includes a plurality of internal baffle walls within the inflatable three-dimensional volume that interface with an interior-facing surface of the base wall; and wherein each roller unit of the set of roller units is mounted to the base wall at a respective location within a region bounded on at least two opposing sides by baffle walls of the plurality of internal baffle walls that interface with the interior-facing surface of the base wall.

Clause 20. The inflatable fall protection pad of any of clauses 1-19, wherein a sidewall of the sidewalls spanning the base wall and the upper wall defines an opening by which air is provided to the inflatable three-dimensional volume defined by the deformable body.

Clause 21. The inflatable fall protection pad of clause 20, further comprising a fan assembly interfacing with the opening to inflate the inflatable three-dimensional volume defined by the deformable body; wherein the fan assembly includes another set of rollers.

Clause 22. The inflatable fall protection pad of any of clauses 1-21, wherein each roller unit of the set of roller units is mounted to the base wall via one or more fasteners.

Clause 23. The inflatable fall protection pad of any of clauses 1-22, wherein the exterior-facing surface of the base wall comprises a different material than an exterior-facing surface of the upper wall.

Clause 24. The inflatable fall protection pad of any of clauses 1-23, wherein the deformable body is foldable along one or more folding paths that are located along one or more regions of the deformable body that do not have one or more roller units mounted to the base wall.

It will be understood that the configurations and/or approaches described herein are exemplary in nature, and that these specific examples are not to be considered in a limiting sense, because numerous variations are possible. The subject matter of the present disclosure includes all novel and non-obvious combinations and sub-combinations of the various examples, configurations, features, functions, and/or properties disclosed herein, as well as any and all equivalents thereof.

1. An inflatable fall protection pad, comprising:
a deformable body defining an inflatable three-dimensional volume, the deformable body having a base wall, an upper wall, and sidewalls spanning the base wall and the upper wall; and
a set of roller units mounted to the base wall along an exterior-facing surface of the base wall, the set of roller units arranged in a multi-dimensional array,
wherein two or more roller units of the set are spaced apart from each other in a first dimension of the multi-dimensional array, and
wherein two or more roller units of the set are spaced apart from each other in a second dimension of the multi-dimensional array that is orthogonal to the first dimension.

2. The inflatable fall protection pad of claim 1, wherein the set of roller units is arranged in three or more rows of the multi-dimensional array in which each row of the three or more rows includes two or more roller units.

3. The inflatable fall protection pad of claim 2, wherein each row of the three or more rows are spaced apart from each other at regular intervals.

4. The inflatable fall protection pad of claim 2, wherein each row of the three or more rows are spaced apart from each other at varying intervals.

5. The inflatable fall protection pad of claim 2, wherein the set of roller units is arranged in three or more columns of the multi-dimensional array in which each column of the three or more columns includes a roller unit of each row of the three or more rows.

6. The inflatable fall protection pad of claim 1, wherein one or more regions of the base wall surrounding each roller unit of the set of roller units is deformable; and
wherein application of a load to the upper wall of the deformable body deforms one or more of said regions of the base wall toward a ground surface upon which the set of roller units support the deformable body.

7. The inflatable fall protection pad of claim 6, wherein one or more of said regions of the base wall is configured to deform toward the ground surface to the extent that at least a portion of the base wall contacts the ground surface when the load is of a predetermined magnitude.

8. The inflatable fall protection pad of claim 7, wherein contact of the ground surface by a portion of the base wall increases a lateral resistance to movement of the inflatable fall protection pad along the ground surface.

9. The inflatable fall protection pad of claim 1, wherein at least a portion of the base wall is configured to contact a ground surface upon which the set of roller units support the deformable body upon application of a load of a predetermined magnitude to the upper wall of the deformable body.

10. The inflatable fall protection pad of claim 9, wherein the surface area of the base wall that contacts the ground surface increases when the magnitude of the load increases.

11. The inflatable fall protection pad of claim 10, wherein contact of the ground surface by a portion of the base wall increases a lateral resistance to movement of the inflatable fall protection pad along the ground surface, and wherein the lateral resistance increases as the surface area of the base wall in contact with the ground surface increases.

12. The inflatable fall protection pad of claim 1, wherein each roller unit of the set of roller units includes:
a rigid body that interfaces with the exterior-facing surface of the base wall, and
one or more rollers rotatably mounted to the rigid body.

13. The inflatable fall protection pad of claim 12, wherein the one or more rollers of each roller unit of the set of roller units include one or more wheels having a fixed rolling orientation.

14. The inflatable fall protection pad of claim 13, wherein the one or more rollers of each roller unit of the set of roller units includes four wheels arranged in a rectangular configuration.

15. The inflatable fall protection pad of claim 13, wherein the sidewalls taper between the base wall and the upper wall on opposite sides of the deformable body; and
wherein the opposite sides of the deformable body are parallel to the fixed rolling orientation.

16. The inflatable fall protection pad of claim 1, wherein the upper wall and the base wall have different areas.

17. The inflatable fall protection pad of claim 1, wherein the deformable body includes a plurality of internal baffle walls within the inflatable three-dimensional volume that interface with an interior-facing surface of the base wall; and
wherein each roller unit of the set of roller units is mounted to the base wall at a respective location within a region bounded on at least two opposing sides by baffle walls of the plurality of internal baffle walls that interface with the interior-facing surface of the base wall.

18. The inflatable fall protection pad of claim 1, wherein a sidewall of the sidewalls spanning the base wall and the upper wall defines an opening by which air is provided to the inflatable three-dimensional volume defined by the deformable body; and
wherein the inflatable fall protection pad further comprises a fan assembly interfacing with the opening to inflate the inflatable three-dimensional volume defined by the deformable body;
wherein the fan assembly includes another set of rollers.

19. The inflatable fall protection pad of claim 1, wherein the exterior-facing surface of the base wall comprises a different material than an exterior-facing surface of the upper wall.

20. The inflatable fall protection pad of claim 1. wherein the deformable body is foldable along one or more folding paths that are located along one or more regions of the deformable body that do not have one or more roller units mounted to the base wall.
